(19) United States
(12) Patent Application Publication
(10) Pub. No.: US 2007/0060716 A1
(43) Pub. Date: Mar. 15, 2007

(54) Fatigue resistant thermoplastic composition, method of making, and articles formed therefrom

(76) Inventors: Bala Ambravaneswaran, Evansville, IN (US); Matthew Robert Pixton, Mt. Vernon, IN (US)

Correspondence Address: CANTOR COLBURN LLP - GE PLASTICS - SMITH, 55 GRIFFIN RD SOUTH, BLOOMFIELD, CT, 06002, US

(21) Appl. No.: 11/225,506

(22) Filed: Sep. 13, 2005

(51) Int. Cl. C08L 69/00; C08L 83/04

(52) U.S. Cl. 525/464; 525/100; 525/468

(57) ABSTRACT

A thermoplastic composition comprises a resin composition comprising a polycarbonate having a weight averaged molecular weight of greater than or equal to 30,000 as measured using gel permeation chromatography, a polysiloxane-polycarbonate comprising 1 to 50 weight percent of siloxane units; and a SAN copolymer, wherein the amounts of polycarbonate, polysiloxane-polycarbonate, and SAN copolymer are selected such that fatigue failure for the thermoplastic composition occurs at greater than or equal to 70,000 cycles at a pressure of 28.2 MPa and a frequency of 5 Hz according to ASTM D638-03 type I, and the viscosity of the thermoplastic composition is less than or equal to 112 Pa-s when measured at a shear rate of 6,000 sec⁻¹ and at 300° C. according to ASTM D4440-01. A method of making the thermoplastic is also disclosed.

### BACKGROUND OF THE INVENTION

This disclosure relates to thermoplastic compositions, and in particular to fatigue resistant thermoplastic compositions, methods of manufacture, and uses thereof.

Thermoplastics have been used extensively to prepare articles that have to endure constant mechanical stresses. In particular, thermoplastics used in the housings for small, lightweight personal electronics devices, such as laptop computers, personal digital assistants (PDAs), cellular telephones, and the like, which are opened frequently and are subject to the accompanying mechanical stress, must provide a high degree of fatigue resistance. Fatigue resistance may be described as the resistance of the thermoplastic to mechanical fatigue, which manifests at the point of fatigue failure as cracks and ultimately as broken stress points in the article. Hinges, for example, are a high stress point in the housing of any of the above and other similar articles, and are prone to fatigue failure. A high fatigue failure point is therefore desirable.

Polycarbonates, which have excellent surface finish, color capability, and mechanical properties, may be used in applications as described above. A high molecular weight polycarbonate may be used to provide a high fatigue failure point. However, high molecular weights may be accompanied by low melt flow properties which can limit the injection molding properties of the polycarbonate. Typical methods of plasticizing polymers to provide improved flow can also result in reduction in or loss of mechanical properties such as, for example, impact strength and fatigue resistance. The usefulness of a polycarbonate in a high fatigue resistance application can, in this way, be mitigated by these secondary considerations of mechanical properties.

There accordingly remains a need in the art for a fatigue resistant thermoplastic composition comprising a polycarbonate.

### SUMMARY OF THE INVENTION

The above deficiencies in the art are alleviated by, in an embodiment a thermoplastic composition comprising a resin composition comprising a polycarbonate having a weight averaged molecular weight of greater than or equal to 30,000 as measured using gel permeation chromatography; a polysiloxane-polycarbonate comprising 1 to 50 weight percent of siloxane units; and a SAN copolymer; wherein the amounts of polycarbonate, polysiloxane-polycarbonate, and SAN copolymer are selected such that fatigue failure for the thermoplastic composition occurs at greater than or equal to 70,000 cycles at a pressure of 28.2 MPa and a frequency of 5 Hz according to ASTM D638-03 type I, and the viscosity of the thermoplastic composition is less than or equal to 112 Pa-s when measured at a shear rate of 6,000 sec⁻¹ and at 300° C. according to ASTM D4440-01.

In another embodiment, a method of making a thermoplastic composition comprises melt blending a polycarbonate having a weight averaged molecular weight of greater than or equal to 30,000 as measured using gel permeation chromatography; a polysiloxane-polycarbonate comprising 1 to 50 weight percent of siloxane units; and a SAN copolymer; wherein the amounts of polycarbonate, polysiloxane-polycarbonate, and SAN copolymer are selected such that fatigue failure for the thermoplastic composition occurs at greater than or equal to 70,000 cycles at a pressure of 28.2 MPa and a frequency of 5 Hz according to ASTM D638-03 type I, and the viscosity of the thermoplastic composition is less than or equal to 112 Pa-s when measured at a shear rate of 6,000 sec⁻¹ and at 300° C. according to ASTM D4440-01.

In another embodiment, an article comprising the thermoplastic composition is disclosed.

The above described and other features are exemplified by the following figures and detailed description.

### BRIEF DESCRIPTION OF THE FIGURES

We refer now to the figures, which are meant to be exemplary, not limiting.

FIG. 1 is a comparison plot of viscosity versus shear rate for thermoplastic compositions.

FIG. 2 is a photograph showing comparative spiral flow performance of different thermoplastic compositions.

### DETAILED DESCRIPTION OF THE INVENTION

Surprisingly, it has been found that a thermoplastic composition comprising a resin composition comprising a high molecular weight polycarbonate, a polysiloxane-polycarbonate, and a styrene-acrylonitrile (SAN) copolymer has, in addition to excellent fatigue resistance, a low viscosity when measured at high shear rate. The thermoplastic composition thus has excellent moldability as well as suitable mechanical properties. A high molecular weight polycarbonate, as disclosed herein, has a molecular weight of greater than or equal to 30,000. Molecular weight, as disclosed herein, is determined using gel permeation chromatography, and is reported in atomic mass units (AMU).

The resin composition comprises a polycarbonate. As used herein, the terms “polycarbonate” and “polycarbonate resin” means compositions having repeating structural carbonate units of the formula (1): 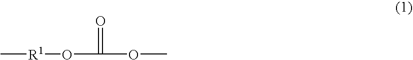
in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2): 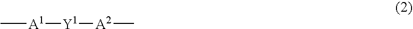
wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)
HO- A¹-Y¹-A²-OH (3)
wherein Y¹, A¹ and A² are as described above. Also included are bisphenol compounds of general formula (4): 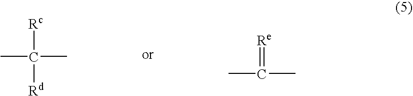
wherein R^{a} and R^{b} each represent a halogen atom or a monovalent hydrocarbon group and may be the same or different; p and q are each independently integers of 0 to 4; and X^{a} represents one of the groups of formula (5): 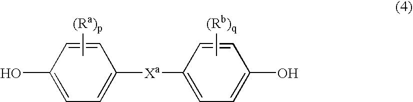
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that may be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds may also be used.

Branched polycarbonates may also be useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. Where used, the branching agents may be added to the polycarbonate at a level of 0.05 to 2.0 wt %.

Branched polycarbonates, where used, may be present in the polycarbonate at less than or equal to 10 wt %, specifically less than or equal to 5 wt %, more specifically less than or equal to 1 wt %, and still more specifically less than or equal to 0.5 wt % of the total weight of the polycarbonate. Branched polycarbonates are thus contemplated as being useful in the polycarbonate, provided that the presence of the branched polycarbonate does not significantly affect desired properties of the thermoplastic compositions.

In an embodiment, the polycarbonate comprises a linear polycarbonate. In a specific embodiment, a linear polycarbonate is a homopolymer derived from bisphenol A, in which each of A¹ and A² is p-phenylene and Y¹ is isopropylidene. Linear polycarbonates may be present in the polycarbonate in an amount of greater than or equal to 90 wt %, specifically greater than or equal to 95 wt %, more specifically greater than or equal to 99 wt %, and still more specifically greater than or equal to 99.5 wt %, of the total weight of the polycarbonate.

The polycarbonates may have an intrinsic viscosity, as determined in chloroform at 25° C., of 0.3 to 1.5 deciliters per gram (dl/g), specifically 0.45 to 1.0 dl/g. The polycarbonates may have a weight average molecular weight (Mw) of 10,000 to 150,000, as measured by gel permeation chromatography (GPC) using a crosslinked styrene-divinyl benzene column, at a sample concentration of 1 milligram per milliliter, and as calibrated with polycarbonate standards. In an embodiment, a suitable polycarbonate has an Mw of greater than or equal to 30,000, specifically greater than or equal to 33,000, and more specifically greater than or equal to 35,000. In another embodiment, a suitable polycarbonate has a high Mw of 30,000 to 150,000, specifically 33,000 to 100,000, and more specifically 35,000 to 50,000, as measured using GPC. In another embodiment, a polycarbonate has a low Mw of 10,000 to less than 30,000. In a specific embodiment, the polycarbonate can be a blend of high and low Mw polycarbonates, wherein the high and low Mw polycarbonates are blended in a weight ratio of 100:0 to 50:50, specifically 100:0 to 80:20, more specifically 100:0 to 90:10.

In one embodiment, the polycarbonate has flow properties suitable for the manufacture of thin articles. Melt volume flow rate (often abbreviated MVR) measures the rate of extrusion of a thermoplastics through an orifice at a prescribed temperature and load. Polycarbonates suitable for the formation of thin articles may have an MVR, measured at 300° C./1.2 kg according to ASTM D1238-04, of 0.5 to 35 cubic centimeters per 10 minutes (cc/10 min). In a specific embodiment, a suitable polycarbonate composition has an MVR measured at 300° C./1.2 kg according to ASTM D1238-04, of 0.5 to 5 cc/10 min, specifically 0.5 to 4.5 cc/10 min, and more specifically 1 to 4 cc/10 min. Mixtures of polycarbonates of different flow properties may be used to achieve the overall desired flow property.

The polycarbonate may have a light transmission greater than or equal to 55%, specifically greater than or equal to 60% and more specifically greater than or equal to 70%, as measured according to ASTM D1003-00. The copolymer has a haze less than or equal to 50%, specifically less than or equal to 40%, and most specifically less than or equal to 30%, as measured according to ASTM D1003-00.

“Polycarbonates” and “polycarbonate resin” as used herein may further include blends of polycarbonates with other copolymers comprising carbonate chain units. A specific suitable copolymer is a polyester carbonate, also known as a copolyester-polycarbonate. Such copolymers further contain, in addition to recurring carbonate chain units of the formula (1), repeating units of formula (6): 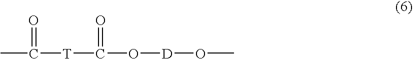
wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to 6 carbon atoms, specifically 2, 3, or 4 carbon atoms; and T divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7): 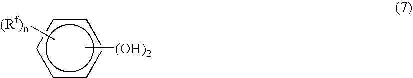
wherein each R^{f} is independently a halogen atom, a C₁₋₁₀ hydrocarbon group, or a C₁₋₁₀ halogen substituted hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is 91:1 to 2:98. In another specific embodiment, D is a C₂₋₆ alkylene radical and T is p-phenylene, m-phenylene, naphthalene, a divalent cycloaliphatic radical, or a mixture thereof This class of polyester includes the poly(alkylene terephthalates).

In addition to the ester units, the polyester polycarbonates can comprise carbonate units as described hereinabove. Carbonate units of formula (1) may also be derived from aromatic dihydroxy compounds of formula (7), wherein specific carbonate units are resorcinol carbonate units.

Specifically, the polyester unit of a polyester-polycarbonate can be derived from the reaction of a combination of isophthalic and terephthalic diacids (or derivatives thereof) with resorcinol, bisphenol A, or a combination comprising at least one of these, wherein the molar ratio of isophthalate units to terephthalate units is 91:9 to 2:98, specifically 85:15 to 3:97, more specifically 80:20 to 5:95, and still more specifically 70:30 to 10:90. The polycarbonate units can be derived from resorcinol and/or bisphenol A, in a molar ratio of resorcinol carbonate units to bisphenol A carbonate units of 0:100 to 99:1, and the molar ratio of the mixed isophthalate-terephthalate polyester units to the polycarbonate units in the polyester-polycarbonate can be 1:99 to 99:1, specifically 5:95 to 90:10, more specifically 10:90 to 80:20. Where a blend of polyester-polycarbonate with polycarbonate is used, the weight ratio of polycarbonate to polyester-polycarbonate in the blend can be, respectively, 1:99 to 99:1, specifically 10:90 to 90:10.

The polyester-polycarbonates may have a weight-averaged molecular weight (Mw) of 1,500 to 100,000, specifically 2,000 to 80,000, and more specifically 3,000 to 50,000. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., 8 to 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. A chain stopper (also referred to as a capping agent) may be included during polymerization. The chain-stopper limits molecular weight growth rate, and so controls molecular weight in the polycarbonate. A chain-stopper may be at least one of mono-phenolic compounds, mono-carboxylic acid chlorides, and/or mono-chloroformates.

For example, mono-phenolic compounds suitable as chain stoppers include monocyclic phenols, such as phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms. A mono-phenolic UV absorber may be used as capping agent. Such compounds include 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like. Specifically, mono-phenolic chain-stoppers include phenol, p-cumylphenol, and/or resorcinol monobenzoate.

Mono-carboxylic acid chlorides may also be suitable as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and mixtures thereof; polycyclic, mono-carboxylic acid chlorides such as trimellitic anhydride chloride, and naphthoyl chloride; and mixtures of monocyclic and polycyclic mono-carboxylic acid chlorides. Chlorides of aliphatic monocarboxylic acids with up to 22 carbon atoms are suitable. Functionalized chlorides of aliphatic monocarboxylic acids, such as acryloyl chloride and methacryoyl chloride, are also suitable. Also suitable are mono-chloroformates including monocyclic, mono-chloroformates, such as phenyl chloroformate, alkyl-substituted phenyl chloroformate, p-cumyl phenyl chloroformate, toluene chloroformate, and mixtures thereof.

The polyester-polycarbonates may be prepared by interfacial polymerization. Rather than utilizing the dicarboxylic acid per se, it is possible, and sometimes even preferred, to employ the reactive derivatives of the acid, such as the corresponding acid halides, in particular the acid dichlorides and the acid dibromides. Thus, for example instead of using isophthalic acid, terephthalic acid, or mixtures thereof, it is possible to employ isophthaloyl dichloride, terephthaloyl dichloride, and mixtures thereof.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be 0.1 to 10 wt % based on the weight of bisphenol in the phosgenation mixture. In another embodiment an effective amount of phase transfer catalyst may be 0.5 to 2 wt % based on the weight of bisphenol in the phosgenation mixture.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

Polyester-polycarbonate resins may also be prepared by interfacial polymerization. Rather than utilizing the dicarboxylic acid per se, it is possible, and sometimes even preferred, to employ the reactive derivatives of the acid, such as the corresponding acid halides, in particular the acid dichlorides and the acid dibromides. Thus, for example instead of using isophthalic acid, terephthalic acid, or mixtures thereof, it is possible to employ isophthaloyl dichloride, terephthaloyl dichloride, and mixtures thereof.

In addition to the polycarbonates described above, it is also possible to use combinations of the polycarbonate with other thermoplastic polymers, for example combinations of polycarbonates and/or polycarbonate copolymers with polyesters. As used herein, a “combination” is inclusive of all mixtures, blends, alloys, reaction products, and the like. Suitable polyesters comprise repeating units of formula (6), and may be, for example, poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

An example of a polyester which can be useful includes poly(alkylene terephthalates). Specific examples of poly(alkylene terephthalates) include, but are not limited to, poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also useful are poly(cyclohexanedimethanol terephthalate)-co-poly(ethylene terephthalate), abbreviated as PETG wherein the polymer comprises greater than or equal to 50 mole % of poly(ethylene terephthalate), and abbreviated as PCTG, wherein the polymer comprises greater than 50 mole % of poly(cyclohexanedimethanol terephthalate). The above polyesters can include the analogous aliphatic polyesters such as poly(alkylene cyclohexanedicarboxylate), a suitable example of which is poly(1,4-cyclohexylenedimethylene-1,4-cyclohexanedicarboxylate) (PCCD). Also contemplated are the above polyesters with a minor amount, e.g., from 0.5 to 10 percent by weight, of units derived from an aliphatic diacid and/or an aliphatic polyol to make copolyesters.

Polycarbonate is thus present in the resin composition in an amount of 65 to 87 wt %, specifically 72 to 86 wt %, and more specifically 73 to 83 wt %, of the total weight of the resin composition, wherein the combined amounts of polycarbonate, polysiloxane-polycarbonate, and SAN copolymer is 100 weight percent of the resin composition.

The resin composition further comprises a polysiloxane-polycarbonate copolymer (also referred to herein as a “polysiloxane-polycarbonate”). The polysiloxane (also referred to herein as “polydiorganosiloxane”) blocks of the polysiloxane-polycarbonate comprise repeating siloxane units (also referred to herein as “diorganosiloxane units”) of formula (8): 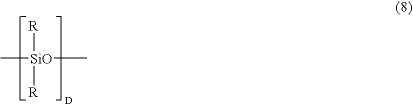
wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. The foregoing groups may be fully or partially halogenated with fluorine, chlorine, bromine, or iodine, or a combination thereof. Combinations of the foregoing R groups may be used in the same copolymer.

The value of D in formula (8) may vary widely depending on the type and relative amount of each component in the thermoplastic composition, the desired properties of the composition, and like considerations. Generally, D may have an average value of 2 to 1,000, specifically 2 to 500, and more specifically 5 to 100. In one embodiment, D has an average value of 10 to 75, and in still another embodiment, D has an average value of 40 to 60. Where D is of a lower value, e.g., less than 40, it may be desirable to use a relatively larger amount of the polysiloxane-polycarbonate. Conversely, where D is of a higher value, e.g., greater than 40, it may be necessary to use a relatively lower amount of the polysiloxane-polycarbonate.

A combination of a first and a second (or more) polysiloxane-polycarbonates may be used, wherein the average value of D of the first polysiloxane-polycarbonate is less than the average value of D of the second polysiloxane-polycarbonate.

In one embodiment, the polydiorganosiloxane blocks are provided by repeating structural units of formula (9): 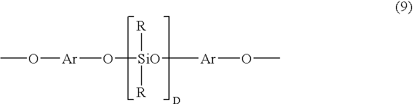
wherein D is as defined above; each R may be the same or different, and is as defined above; and each Ar may be the same or different, and is a substituted or unsubstituted C₆-C₃₀ arylene radical, wherein the bonds are directly connected to an aromatic moiety. Suitable Ar groups in formula (9) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulphide), and 1,1-bis(4-hydroxy-t-butylphenyl) propane. Combinations comprising at least one of the foregoing dihydroxy compounds may also be used.

Such units may be derived from the corresponding dihydroxy compound of formula (10): 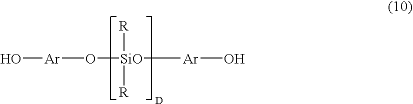
wherein R, Ar, and D are as described above. Compounds of formula (10) may be obtained by the reaction of a dihydroxyarylene compound with, for example, an alpha, omega-bisacetoxypolydiorangonosiloxane under phase transfer conditions.

In another embodiment, polydiorganosiloxane blocks comprise units of formula (11): 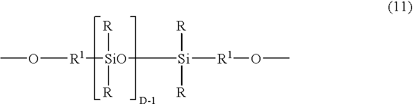
wherein R and D are as described above, and each occurrence of R¹ is independently a divalent C₁-C₃₀ alkylene, and wherein the polymerized polysiloxane unit is the reaction residue of its corresponding dihydroxy compound. Polysiloxane blocks of formula (11) are thus free of Si—O—C bonds, and so are useful in compositions where increased chemical and hydrolytic stability is desired. In a specific embodiment, the polydiorganosiloxane blocks are provided by repeating structural units of formula (12): 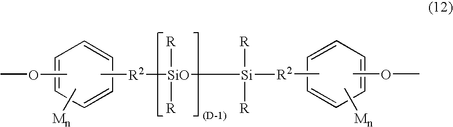
wherein R and D are as defined above. Each R² in formula (12) is a divalent C₂-C₈ aliphatic group. Each M in formula (12) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

Units of formula (12) may be derived from the corresponding dihydroxy polydiorganosiloxane (13): 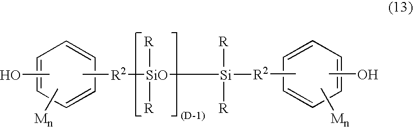
wherein R, D, M, R², and n are as described above. Such dihydroxy polysiloxanes can be made by effecting a platinum catalyzed addition between a siloxane hydride of formula (14): 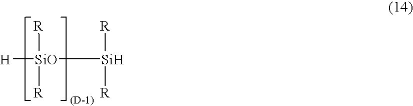
wherein R and D are as previously defined, and an aliphatically unsaturated monohydric phenol. Suitable aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used. In an embodiment, a useful polysiloxane-polycarbonate, prepared using this method, is free of Si—O—C bonds.

The polysiloxane-polycarbonate comprises 50 to 99 wt % of carbonate units and 1 to 50 wt % siloxane units. Within this range, the polysiloxane-polycarbonate may comprise 70 to 98 wt %, specifically 75 to 97 wt % of carbonate units and 2 to 30 wt %, specifically 3 to 25 wt % siloxane units.

The polysiloxane-polycarbonate may have a light transmission greater than or equal to 55%, specifically greater than or equal to 60% and more specifically greater than or equal to 70%, as measured according to ASTM D1003-00. The polysiloxane-polycarbonate may have a haze less than or equal to 50%, specifically less than or equal to 40%, and most specifically less than or equal to 30%, as measured according to ASTM D1003-00.

In one specific embodiment, the polysiloxane-polycarbonate comprises polysiloxane units, and carbonate units derived from bisphenol A, i.e., the dihydroxy compound of formula (3) in which each of A¹ and A² is p-phenylene and Y¹ is isopropylidene. Polysiloxane-polycarbonates may have a weight average molecular weight of 2,000 to 100,000, specifically 5,000 to 50,000 as measured by gel permeation chromatography using a crosslinked styrene-divinyl benzene column, at a sample concentration of 1 milligram per milliliter, and as calibrated with polycarbonate standards.

The polysiloxane-polycarbonate can have a melt volume flow rate, measured at 300° C./1.2 kg, of 1 to 35 cubic centimeters per 10 minutes (cc/10 min), specifically 2 to 30 cc/10 min. Mixtures of polysiloxane-polycarbonates of different flow properties may be used to achieve the overall desired flow property.

The resin composition comprises a polysiloxane-polycarbonate in an amount effective to maintain at least one mechanical property of the thermoplastic composition prepared therefrom, in the presence of further components. Polysiloxane-polycarbonate is thus present in the resin composition in an amount of 3 to 15 wt %, specifically 4 to 13 wt %, and more specifically 5 to 12 wt %, wherein the combined amounts of polycarbonate, polysiloxane-polycarbonate, and SAN copolymer is 100 weight percent of the resin composition.

The polysiloxane content of the resin composition, as provided by the polysiloxane-polycarbonate present therein, can thus be present in an amount of 0.6 to 3 wt %, specifically 0.8 to 2.6 wt %, and more specifically 1 to 2.4 wt %, of the resin composition, wherein the combined amounts of polycarbonate, polysiloxane-polycarbonate, and SAN copolymer is 100 weight percent of the resin composition.

The resin composition used in the thermoplastic composition further comprises a nitrile-containing aromatic copolymer, containing structural units derived from at least one ethylenically unsaturated nitrile such as, for example, acrylonitrile, methacrylonitrile or fumaronitrile. Acrylonitrile is specifically useful. Vinyl aromatic compounds are copolymerized with the ethylenically unsaturated nitrile monomer to forma a copolymer, wherein the vinylaromatic compounds can include monomers of formula (15): 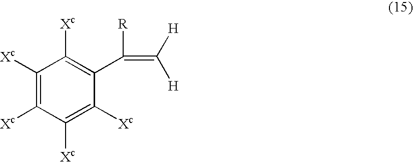
wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds.

Suitable nitrile-containing aromatic copolymer of this type include styrene-acrylonitrile copolymers, α-methylstyrene-acrylonitrile copolymers, acrylonitrile-styrene-methacrylic acid ester terpolymers, acrylonitrile-butadiene-styrene (ABS) resins, acrylonitrile-ethyl acrylate-styrene copolymers and rubber-modified acrylonitrile-styrene-butyl acrylate polymers. In an embodiment, a suitable nitrile-containing aromatic copolymer is a styrene-acrylonitrile (SAN) copolymer derived from styrene and acrylonitrile.

Styrene-acrylonitrile (SAN) copolymers are typically used as impact modifiers, and are specifically useful herein. Suitable SAN copolymers comprise 5 to 40 wt %, specifically 15 to 35 wt %, and more specifically 20 to 30 wt % ethylenically unsaturated nitrile units. Specifically, a SAN copolymer can comprise about 75 wt % styrene and about 25 wt % acrylonitrile units irrespective of the monomer proportions in the copolymerization mixture, and those are therefore the proportions most often used. The weight average molecular weight of the SAN copolymer can be 30,000 to 150,000, specifically 40,000 to 100,000, more specifically 50,000 to 90,000, as determined by gel permeation chromatography relative to polystyrene standards.

The thermoplastic composition thus comprises a resin composition comprising the SAN copolymer, the polycarbonate, and the polysiloxane-polycarbonate. The SAN copolymer is present in the resin composition in an amount of 10 to 20 wt %, specifically 10 to 15 wt %, and more specifically 12 to 15 wt % wherein the combined amounts of polycarbonate, polysiloxane-polycarbonate, and SAN copolymer is 100 weight percent of the resin composition.

It has been observed that use of high molecular weight polycarbonates (Mw of greater than or equal to 30,000), can provide improved mechanical properties in an article prepared from the polycarbonate. Specifically, fatigue resistance is a desirable property in articles prepared from thermoplastic compositions comprising polycarbonates, wherein fatigue resistance has been found to increase with the 6-7^{th} power of molecular weight. Linear polymers can have better fatigue resistance than branched polymers. Use of high molecular weight polycarbonate combined with a SAN copolymer can provide improvements to melt flow and to one or more mechanical properties of the polycarbonate such as, for example, flexural modulus. However, the presence of SAN copolymer in high concentrations (greater than 20 weight percent) can also reduce other mechanical properties of the combination relative to polycarbonate, particularly at low temperatures.

Significantly, the presence of SAN copolymer affects the fatigue resistance of a polycarbonate. Fatigue resistance describes the mechanical resilience of a polymer for applications in which constant mechanical stresses are applied to specific parts of an article prepared from the thermoplastic composition, and is tested for by repeatedly stressing the article, at a regular rate and under a consistent load, to the point of breaking. The fatigue failure point, a measure of fatigue resistance, of a polycarbonate-SAN composition can be 30,000 cycles or lower, which may be unsuitable for applications that put a constant repetitive stress on an article prepared from the composition. While it is not required to provide an explanation of how an invention works, such theories may be useful for the purposes of better helping the reader to comprehend the invention. It is to be understood therefore that the claims are not to be limited by the following theory of operation. Thus, without wishing to be bound by theory, it is believed that the SAN is immiscible with the polycarbonate and can form isolated regions within the polycarbonate matrix, and the polycarbonate matrix and SAN regions may thus be more prone to phase separate. This leading to increased brittleness in the polycarbonate-SAN composition, which can compromise the mechanical properties of the polycarbonate. Brittle materials can undergo fatigue failure sooner than non-brittle (i.e., plastic) materials, and therefore the polycarbonate-SAN composition can undergo fatigue failure sooner than a polycarbonate without SAN. At both high SAN loadings of greater than 20 wt %, and at low temperatures of, for example, 0° C. or lower, brittleness of the polycarbonate-SAN blend can increase, and the mechanical properties can therefore be degraded further. Impact modifiers, when blended with a material such as a polycarbonate, can increase the stiffness of the material, and thereby improve one or more of the mechanical properties; however, use of typical impact modifiers, based on the performance of the SAN, was not expected to provide sufficient improvement.

Surprisingly, it has been found that addition of a polysiloxane-polycarbonate to a combination of a polycarbonate comprising greater than or equal to 90 weight percent of linear polycarbonate, and a SAN copolymer, provides a resin composition which, when included in a thermoplastic composition from which articles are prepared, provides a lower viscosity relative to a polycarbonate-SAN composition without polysiloxane-polycarbonate at high shear rates (greater than 6,000 per second). This lower viscosity in turn provides improved flow properties under conditions of high shear for a thermoplastic composition comprising the resin composition. The thermoplastic composition also has a significantly improved fatigue failure point in the thermoplastic composition and the article, while maintaining or improving one or more of the mechanical properties of the polycarbonate without SAN copolymer present. It is believed that the polysiloxane-polycarbonate improves the plasticity of the polycarbonate phase in the blend, improving the compatibility between the SAN and polycarbonate phases at lower temperatures (0° C. or less) and allowing the use of lower SAN loadings to achieve desirable rheological performance such as, for example, low viscosity at high shear rates (greater than or equal to 6,000 sec⁻¹), and melt flow performance, mitigating adverse effects of SAN loading on mechanical properties. The inclusion of the polysiloxane-polycarbonate in the thermoplastic composition described above thus allows use of higher molecular weight linear polycarbonates (Mw of greater than or equal to 30,000), which in addition to the higher fatigue resistance, provides a higher viscosity at low shear rates of less than or equal to 100 sec⁻¹, relative to the polycarbonate and SAN copolymer combination without polysiloxane-polycarbonate.

The shear thinning thus provides improved flow of the thermoplastic composition, specifically when used with high shear processes such as injection molding which has a typical shear rate of 6,000 to 20,000 sec⁻¹. Advantageously, lower viscosity at high shear rates (shear thinning behavior) can provide improved mold filling capability. The higher viscosity at low shear rates can improve the ductility of the thermoplastic composition, and can thus be advantageous for low shear processes such as extrusion, which has a typical shear rate of less than or equal to 150 sec

Thus, fatigue failure of the thermoplastic composition occurs at greater than or equal to 70,000 cycles, specifically greater than or equal to 80,000 cycles, more specifically greater than or equal to 90,000 cycles, and still more specifically greater than or equal to 100,000 cycles, measured at 4,000 pounds per square inch (28.3 mega-Pascals or MPa) at a frequency of 5 Hertz (Hz) according to ASTM D638-03 (type I).

The viscosity of the thermoplastic composition can be less than or equal to 112 Pascal-seconds (Pa-s), specifically less than or equal to 110 Pa-s, more specifically less than or equal to 108 Pa-s, and still more specifically less than or equal to 105 Pa-s, when measured at a shear rate of 6,000 sec⁻¹ and at 300° C. using ASTM D4440-01. The viscosity of the thermoplastic composition can be greater than or equal to 900 Pascal-seconds (Pa-s), greater than or equal to 902 Pa-s, greater than or equal to 905 Pa-s, greater than or equal to 910 Pa-s, when measured at a shear rate of 25 sec⁻¹ and at 300° C. according to ASTM D4440-01.

In addition to the resin composition, the thermoplastic composition can include various additives ordinarily incorporated with resin compositions of this type, with the proviso that the additives are selected so as not to adversely affect the desired properties of the thermoplastic composition. Mixtures of additives may be used. Such additives may be mixed at a suitable time during the mixing of the components for forming the thermoplastic composition.

The thermoplastic composition may comprise a colorant such as a pigment and/or dye additive. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates, sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments can be used in amounts of 0.01 to 10 percent by weight, based on 100 percent by weight of the resin composition, excluding any other additives and/or fillers.

Suitable dyes can be organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Dyes can be used in amounts of 0.01 to 10 percent by weight, based on 100 percent by weight of the resin composition, excluding any other additives and/or fillers.

In addition to the SAN copolymers disclosed above, the thermoplastic composition may include an additional impact modifier to increase its impact resistance, where the impact modifier is present in an amount that does not adversely affect the desired properties of the thermoplastic composition. These impact modifiers include elastomer-modified graft copolymers comprising (i) an elastomeric (i.e., rubbery) polymer substrate having a Tg less than 10° C., more specifically less than −10° C., or more specifically −40° to −80° C., and (ii) a rigid polymeric superstrate grafted to the elastomeric polymer substrate. As is known, elastomer-modified graft copolymers may be prepared by first providing the elastomeric polymer, then polymerizing the constituent monomer(s) of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Suitable materials for use as the elastomer phase may include, for example, conjugated diene rubbers; copolymers of a conjugated diene with less than 50 wt % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

Suitable conjugated diene monomers for preparing the elastomer phase may be of formula (16): 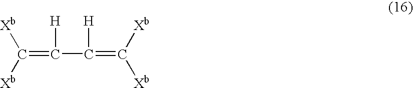
wherein each X^{b} is independently hydrogen, C₁-C₅ alkyl, or the like. Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of a conjugated diene rubber may also be used, for example those produced by aqueous radical emulsion polymerization of a conjugated diene and one or more monomers copolymerizable therewith. Monomers that are suitable for copolymerization with the conjugated diene include monovinylaromatic monomers containing condensed aromatic ring structures, such as vinyl naphthalene, vinyl anthracene and the like, or monomers of formula (15). Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be used as monomers copolymerizable with the conjugated diene monomer.

Other monomers that may be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (17): 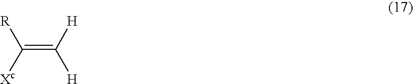
wherein R is hydrogen, C₁-C₅ alkyl, bromo, or chloro, and X^{c} is C₁-C₁₂ alkoxycarbonyl, C₁-C₁₂ aryloxycarbonyl, hydroxy carbonyl, or the like. Examples of monomers of formula (17) include, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Mixtures of the foregoing monovinyl monomers and monovinylaromatic monomers may also be used.

Suitable (meth)acrylate monomers suitable for use as the elastomeric phase may be cross-linked, particulate emulsion homopolymers or copolymers of C₁₋₈ alkyl (meth)acrylates, in particular C₄-₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers may optionally be polymerized in admixture with up to 15 wt % of comonomers of formulas (15), (16), or (17). Exemplary comonomers include but are not limited to butadiene, isoprene, styrene, methyl methacrylate, phenyl methacrylate, penethylmethacrylate, N-cyclohexylacrylamide, vinyl methyl ether, and mixtures comprising at least one of the foregoing comonomers. Optionally, up to 5 wt % a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase may be polymerized by mass, emulsion, suspension, solution or combined processes such as bulk-suspension, emulsion-bulk, bulk-solution or other techniques, using continuous, semibatch, or batch processes. The particle size of the elastomer substrate is not critical. For example, an average particle size of 0.001 to 25 micrometers, specifically 0.01 to 15 micrometers, or even more specifically 0.1 to 8 micrometers may be used for emulsion based polymerized rubber lattices. A particle size of 0.5 to 10 micrometers, specifically 0.6 to 1.5 micrometers may be used for bulk polymerized rubber substrates. Particle size may be measured by simple light transmission methods or capillary hydrodynamic chromatography (CHDF). The elastomer phase may be a particulate, moderately cross-linked conjugated butadiene or C₄₋₆ alkyl acrylate rubber, and preferably has a gel content greater than 70 wt %. Also suitable are mixtures of butadiene with styrene and/or C₄₋₆ alkyl acrylate rubbers.

The elastomeric phase may provide 5 to 95 wt % of the total graft copolymer, more specifically 20 to 90 wt %, and even more specifically 40 to 85 wt % of the elastomer-modified graft copolymer, the remainder being the rigid graft phase.

The rigid phase of the elastomer-modified graft copolymer may be formed by graft polymerization of a mixture comprising a monovinylaromatic monomer and optionally one or more comonomers in the presence of one or more elastomeric polymer substrates. The above-described monovinylaromatic monomers of formula (15) may be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Suitable comonomers include, for example, the above-described monovinylic monomers and/or monomers of the general formula (17). In one embodiment, R is hydrogen or C₁-C₂ alkyl, and X^{c} is cyano or C₁-C₁₂ alkoxycarbonyl. Specific examples of suitable comonomers for use in the rigid phase include, methyl (meth)acrylate, ethyl (meth)acrylate, n-propyl (meth)acrylate, isopropyl (meth)acrylate, and the like, and combinations comprising at least one of the foregoing comonomers.

The relative ratio of monovinylaromatic monomer and comonomer in the rigid graft phase may vary widely depending on the type of elastomer substrate, type of monovinylaromatic monomer(s), type of comonomer(s), and the desired properties of the impact modifier. The rigid phase may generally comprise up to 100 wt % of monovinyl aromatic monomer, specifically 30 to 100 wt %, more specifically 50 to 90 wt % monovinylaromatic monomer, with the balance being comonomer(s).

Depending on the amount of elastomer-modified polymer present, a separate matrix or continuous phase of ungrafted rigid polymer or copolymer may be simultaneously obtained along with the elastomer-modified graft copolymer. Typically, such impact modifiers comprise 40 to 95 wt % elastomer-modified graft copolymer and 5 to 65 wt % graft (co)polymer, based on the total weight of the impact modifier. In another embodiment, such impact modifiers comprise 50 to 85 wt %, more specifically 75 to 85 wt % rubber-modified graft copolymer, together with 15 to 50 wt %, more specifically 15 to 25 wt % graft (co)polymer, based on the total weight of the impact modifier.

Another specific type of elastomer-modified impact modifier comprises structural units derived from at least one silicone rubber monomer, a branched acrylate rubber monomer having the formula H₂C═C(R^{d})C(O)OCH₂CH₂R^{e}, wherein R^{d} is hydrogen or a C₁-C₈ linear or branched alkyl group and R^{e} is a branched C₃-C₁₆ alkyl group; a first graft link monomer; a polymerizable alkenyl-containing organic material; and a second graft link monomer. The silicone rubber monomer may comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane., octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and the like, alone or in combination. The polymerizable, alkenyl-containing organic material may be, for example, a monomer of formula (15) or (17), e.g., styrene, alpha-methylstyrene, or an unbranched (meth)acrylate such as methyl methacrylate, 2-ethylhexyl methacrylate, methyl acrylate, ethyl acrylate, n-propyl acrylate, or the like, alone or in combination.

The at least one first graft link monomer may be an (acryloxy)alkoxysilane, a (mercaptoalkyl)alkoxysilane, a vinylalkoxysilane, or an allylalkoxysilane, alone or in combination, e.g., (gamma-methacryloxypropyl) (dimethoxy)methylsilane and/or (3-mercaptopropyl) trimethoxysilane. The at least one second graft link monomer is a polyethylenically unsaturated compound having at least one allyl group, such as allyl methacrylate, triallyl cyanurate, or triallyl isocyanurate, alone or in combination.

The silicone-acrylate impact modifier compositions can be prepared by emulsion polymerization, wherein, for example at least one silicone rubber monomer is reacted with at least one first graft link monomer at a temperature from 30° C. to 110° C. to form a silicone rubber latex, in the presence of a surfactant such as dodecylbenzenesulfonic acid. Alternatively, a cyclic siloxane such as cyclooctamethyltetrasiloxane and tetraethoxyorthosilicate may be reacted with a first graft link monomer such as (gamma-methacryloxypropyl) methyldimethoxysilane, to afford silicone rubber having an average particle size from 100 nanometers to 2 micrometers. At least one branched acrylate rubber monomer is then polymerized with the silicone rubber particles, optionally in presence of a cross linking monomer, such as allylmethacrylate in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid may be separated from the aqueous phase through coagulation (by treatment with a coagulant) and dried to a fine powder to produce the silicone-acrylate rubber impact modifier composition. This method can be generally used for producing the silicone-acrylate impact modifier having a particle size from 100 nanometers to 2 micrometers 2 micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semibatch, or batch processes.

The foregoing types of impact modifiers, including SAN copolymers, can be prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization, and may catalyze transesterification and/or degradation of polycarbonates. Instead, ionic sulfate, sulfonate or phosphate surfactants may be used in preparing the impact modifiers, particularly the elastomeric substrate portion of the impact modifiers. Suitable surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, and mixtures thereof. A specific surfactant is a C₆₋₁₆, specifically a C₈₋₁₂ alkyl sulfonate. In the practice, any of the above-described impact modifiers may be used providing it is free of the alkali metal salts of fatty acids, alkali metal carbonates and other basic materials.

A specific impact modifier of this type is an MBS impact modifier wherein the butadiene substrate is prepared using above-described sulfonates, sulfates, or phosphates as surfactants. It is also preferred that the impact modifier have a pH of 3 to 8, specifically 4 to 7. When present, impact modifiers can be present in the thermoplastic composition in amounts of 0.1 to 30 percent by weight, based on 100 percent by weight of the resin composition, excluding any other additives and/or fillers.

The thermoplastic composition may include fillers or reinforcing agents. Where used, suitable fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers and reinforcing agents may be coated with a layer of metallic material to facilitate conductivity, or surface treated with silanes to improve adhesion and dispersion with the polymeric matrix resin. In addition, the reinforcing fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. Fillers can be used in amounts of 0 to 90 percent by weight, based on 100 percent by weight of the resin composition, excluding any other additives and/or fillers.

Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of paracresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants can be used in amounts of 0.0001 to 1 percent by weight, based on 100 percent by weight of the resin composition, excluding any other additives and/or fillers.

Suitable heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 percent by weight, based on 100 percent by weight of the resin composition, excluding any other additives and/or fillers.

Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers can be used in amounts of 0.0001 to 1 percent by weight, based on 100 percent by weight of the resin composition, excluding any other additives and/or fillers.

Suitable UV absorbing additives include for example, hydroxybenzophenones; hydroxybenzotriazoles; hydroxybenzotriazines; cyanoacrylates; oxanilides; benzoxazinones; 2- (2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4- phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl] propane; nano-size inorganic materials such as titanium oxide, cerium oxide, and zinc oxide, all with particle size less than 100 nanometers; or the like, or combinations comprising at least one of the foregoing UV absorbers. UV absorbers can be used in amounts of 0.0001 to 1 percent by weight, based on 100 percent by weight of the resin composition, excluding any other additives and/or fillers.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfinctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.0001 to 1 percent by weight, based on 100 percent by weight of the resin composition, excluding any other additives and/or fillers.

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example Pelestat™ 6321 (Sanyo) or Pebax™ MH1657 (Atofina), Irgastat™ P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents can be used in amounts of 0.0001 to 5 percent by weight, based on 100 percent by weight of the resin composition, excluding any other additives and/or fillers.

Suitable flame retardant that may be added may be organic compounds that include phosphorus, bromine, and/or chlorine. Non-brominated and non-chlorinated phosphorus-containing flame retardants may be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate. Other suitable aromatic phosphates may be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfinctional aromatic phosphorus-containing compounds are also useful, for example, compounds of the formulas below: 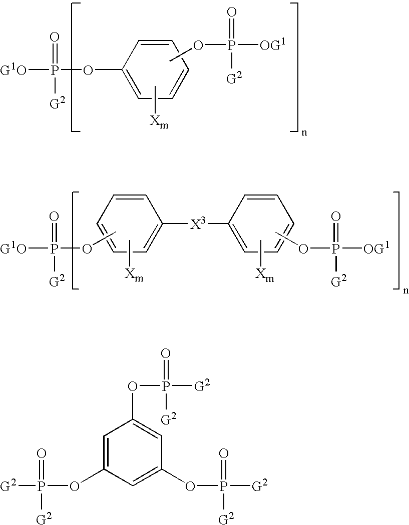
wherein each G¹ is independently a hydrocarbon having 1 to 30 carbon atoms; each G² is independently a hydrocarbon or hydrocarbonoxy having 1 to 30 carbon atoms; each X^{a} is independently a hydrocarbon having 1 to 30 carbon atoms; each X is independently a bromine or chlorine; m is 0 to 4, and n is 1 to 30. Examples of suitable di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like.

Exemplary suitable flame retardant compounds containing phosphorus-nitrogen bonds include phosphonitrilic chloride, phosphorus ester amides, phosphoric acid amides, phosphonic acid amides, phosphinic acid amides, tris(aziridinyl) phosphine oxide. When present, phosphorus-containing flame retardants can be present in amounts of 0.1 to 10 percent by weight, based on 100 percent by weight of the resin composition, excluding any other additives and/or fillers.

Halogenated materials may also be used as flame retardants, for example halogenated compounds and resins of formula (18): 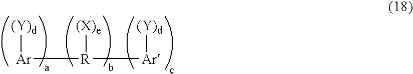
wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (18) are each independently mono- or polycarbocyclic aromatic groups such as phenylene, biphenylene, terphenylene, naphthylene, or the like.

Y is an organic, inorganic, or organometallic radical, for example: halogen, e.g., chlorine, bromine, iodine, fluorine; ether groups of the general formula OE, wherein E is a monovalent hydrocarbon radical similar to X; monovalent hydrocarbon groups of the type represented by R; or other substituents, e.g., nitro, cyano, and the like, said substituents being essentially inert provided that there is at least one and preferably two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group may itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c may be 0. Otherwise either a or c, but not both, may be 0. Where b is 0, the aromatic groups are joined by a direct carbon-carbon bond.

The hydroxyl and Y substituents on the aromatic groups, Ar and Ar′, can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant. When present, halogen containing flame retardants can be present in amounts of 0.1 to 10 percent by weight, based on 100 percent by weight of the resin composition, excluding any other additives and/or fillers.

Inorganic flame retardants may also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆, and/or Na₃AlF₆ or the like. When present, inorganic flame retardant salts can be present in amounts of 0.1 to 5 percent by weight, based on 100 percent by weight of the resin composition, excluding any other additives and/or fillers.

Anti-drip agents may also be used, for example a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A suitable TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. Antidrip agents can be used in amounts of 0.1 to 5 percent by weight, based on 100 percent by weight of the resin composition, excluding any other additives and/or fillers.

Radiation stabilizers may also be present, specifically gamma-radiation stabilizers. Suitable gamma-radiation stabilizers include diols, such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), and the like, and polyols, as well as alkoxy-substituted cyclic or acyclic alkanes. Alkenols, with sites of unsaturation, are also a useful class of alcohols, examples of which include 4-methyl-4-penten-2-ol, 3-methyl-pentene-3-ol, 2-methyl-4-penten-2-ol, 2,4-dimethyl-4-pene-2-ol, and 9-decen-1-ol. Another class of suitable alcohols is the tertiary alcohols, which have at least one hydroxy substituted tertiary carbon. Examples of these include 2-methyl-2,4-pentanediol (hexylene glycol), 2-phenyl-2-butanol, 3-hydroxy-3-methyl-2-butanone, 2-phenyl-2-butanol, and the like,, and cycoloaliphatic tertiary carbons such as 1-hydroxy-1-methyl-cyclohexane. Another class of suitable alcohols is hydroxymethyl aromatics, which have hydroxy substitution on a saturated carbon attached to an unsaturated carbon in an aromatic ring. The hydroxy substituted saturated carbon may be a methylol group (—CH₂OH) or it may be a member of a more complex hydrocarbon group such as would be the case with (—CR⁴HOH) or (—CR⁴₂⁴OH) wherein R⁴ is a complex or a simple hydrocarbon. Specific hydroxy methyl aromatics may be benzhydrol, 1,3-benzenedimethanol, benzyl alcohol, 4-benzyloxy benzyl alcohol and benzyl benzyl alcohol. Specific alcohols are 2-methyl-2,4-pentanediol (also known as hexylene glycol), polyethylene glycol, and polypropylene glycol. Gamma-radiation stabilizing compounds are typically used in amounts of 0.001 to 1 wt %, more specifically 0.01 to 0.5 wt %, based on the resin composition, excluding any other additives and/or fillers.

In one embodiment, the thermoplastic composition comprises a resin composition comprising 65 to 87 wt % of the polycarbonate; 3 to 15 wt % of polysiloxane-polycarbonate; and 10 to 20 wt % of SAN copolymer. In another embodiment, the thermoplastic composition comprises a resin composition comprising 72 to 86 wt % polycarbonate, 4 to 13 wt % polysiloxane-polycarbonate; and 10 to 15 wt % of SAN copolymer. In another embodiment, the thermoplastic composition comprises a resin composition comprising 73 to 83 wt % polycarbonate resin; 5 to 12 wt % polysiloxane-polycarbonate; and 12 to 15 wt % of SAN copolymer. The combined amounts of polycarbonate, polysiloxane-polycarbonate, and SAN copolymer is 100 weight percent of the resin composition. In a specific embodiment, the thermoplastic composition may further comprise an additional impact modifier, filler, antioxidant, heat stabilizer, light stabilizer, ultraviolet light absorber, plasticizer, mold release agent, lubricant, antistatic agent, pigment, dye, flame retardant, anti-drip agent, or a combination comprising at least one of these.

In an embodiment, the notched Izod impact strength (NII) for the thermoplastic composition can be greater than or equal to 70 kilogram-centimeters per centimeter (Kg-cm/cm), specifically greater than or equal to 80 Kg-cm/cm, more specifically greater than or equal to 85 Kg-cm/cm, and still more specifically greater than or equal to 90 Kg-cm/cm, measured at 23° C. on 3.18 mm molded bars using the method of ASTM D256-04.

In an embodiment, the flexural modulus of the thermoplastic composition can be greater than or equal to 23,000 Kg/cm², specifically greater than or equal to 24,000 Kg/cm², more specifically greater than or equal to 25,000 Kg/cm², and still more specifically greater than or equal to 25,250 Kg/cm , as measured according to ASTM D790-03.

In an embodiment, the melt volume rate (MVR) of the thermoplastic composition can be less than or equal to 10 cc/10 min, specifically less than or equal to 8 cc/10 min, more specifically less than or equal to 7 cc/10 min, and more specifically less than or equal to 6.8 cc/10 min, at 300° C. and 1.2 Kg applied weight, according to ASTM D1238-04. In another embodiment, the melt volume rate (MVR) of the thermoplastic composition can be less than or equal to 11 cc/10 min, specifically less than or equal to 9 cc/10 min, more specifically less than or equal to 8 cc/10 min, and more specifically less than or equal to 7 cc/10 min, at 250° C. and 10 Kg applied weight, according ASTM D1238-04.

The thermoplastic composition may be manufactured by methods generally available in the art, for example, in one embodiment, in one manner of proceeding, powdered polycarbonate, polysiloxane-polycarbonate, SAN copolymer, and/or other optional components are first blended, in a HENSCHEL-Mixer® high speed mixer. Other low shear processes including but not limited to hand mixing may also accomplish this blending. The blend is then fed into the throat of an extruder via a hopper. Alternatively, one or more of the components may be incorporated into the composition by feeding directly into the extruder at the throat and/or downstream through a sidestuffer. Additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate may be one-fourth inch long or less as desired. Such pellets may be used for subsequent molding, shaping, or forming.

In a specific embodiment, a method of preparing a thermoplastic composition comprises melt combining a polycarbonate, a polysiloxane-polycarbonate, and the SAN copolymer to form a resin composition. The melt combining can be done by extrusion. In an embodiment, the proportions of polysiloxane-polycarbonate, SAN copolymer, and polycarbonate are selected such that the mechanical properties of the thermoplastic composition are maximized while the fatigue resistance is at a desirable level.

In a specific embodiment, the extruder is a twin-screw extruder. The extruder is typically operated at a temperature of 180 to 385° C., specifically 200 to 330° C., more specifically 220 to 300° C., wherein the die temperature may be different. The extruded thermoplastic composition is quenched in water and pelletized.

Shaped, formed, or molded articles comprising the thermoplastic compositions are also provided. The thermoplastic compositions may be molded into useful shaped articles by a variety of means such as injection molding, extrusion, rotational molding, blow molding and thermoforming. In a specific embodiment, molding is done by injection molding. Desirably, the thermoplastic composition has excellent mold filling capability and is useful to form articles such as, for example, computer and business machine housings such as housings for monitors, handheld electronic device housings such as housings for cell phones, stadium seating (folding), folding chairs, home appliances, and automobile components such as molded interior panels, fenders, decorative trim, bumpers, and the like.

The thermoplastic composition is further illustrated by the following non-limiting examples, prepared using the components shown in Table 1.

TABLE 1

| | | |
|---|---|---|
| BPA-PC HF | BPA polycarbonate resin | GE Plastics |
| | (high-flow), Mw = 21,900 | |
| BPA-PC 30K | BPA polycarbonate resin, | GE Plastics |
| | Mw = 30,000 | |
| BPA-PC 35K | BPA polycarbonate resin, | GE Plastics |
| | Mw = 35,000 | |
| PC-Siloxane | Polydimethylsiloxane - | GE Plastics |
| | bisphenol A polycarbonate | |
| | copolymer, 20 wt % | |
| | polydimethylsiloxane | |
| | content, Mw = 20,000 | |
| SAN | Styrene-acrylonitrile | GE Plastics |
| | copolymer (impact modifier) | |
| | having 75 wt % styrene/25 wt % | |
| | acrylonitrile, Mw 70,000 | |
| PETS | Pentaerythritol tetrastearate | — |
| | (plasticizer/mold release | |
| | agent) | |
| PMMA | Poly(methyl methacrylate) | Rohm and |
| | (plasticizer/mold release | Haas |
| | agent) | |
| I-168 | Irgafos ® 168 Antioxidant | Ciba Specialty |
| | (Tris(2,6 di tert- | Chemicals |
| | butylphenyl)phosphite) | |
| Pigment 1 | SICOTAN ® Pigment Brown 24 | BASF |
| Pigment 2 | Coated TiO₂ Pigment | — |
| Pigment 3 | Copperas Iron Oxide Pigment | Elementis |
| | | Pigments |
| Pigment 4 | Carbon Black Pigment | Cabot |
| | | Corporation |
| Pigment 5 | Light Yellow 6R Pigment | Bayer |
| Pigment 6 | Arctic Blue No. 3 Pigment | Shepherd |
| | | Color Company |

All thermoplastic compositions except where indicated are compounded on a Werner & Pfleiderer co-rotating twin screw extruder (Length/Diameter (L/D) ratio=30/1, vacuum port located near die face). The twin-screw extruder had enough distributive and dispersive mixing elements to produce good mixing between the polymer compositions. The compositions are subsequently molded according to ISO 294 on a Husky or BOY injection molding machine. Compositions are compounded and molded at a temperature of 285 to 330° C., though it will be recognized by one skilled in the art that the method may not be limited to these temperatures.

Fatigue testing was determined at a pressure of 28.4 MPa at a frequency of 5 Hz, according to ASTM D638-03 type I, wherein the failure point is reported in no. of cycles to failure. Viscosity is reported in Pascal-seconds (Pa-s) and is determined at shear rates of 10 to 9,000 sec⁻¹ according to ASTM D4440-01. Melt volume rate (MVR) was determined at 300° C. using a 1.2 kilogram weight, or at 250° C. using a 10 kg weight, over 10 minutes in accordance with ASTM D1238. Heat deformation temperature (HDT) was determined on one-eighth inch (3.18 mm) bars according to the method of ASTM D648. Notched Izod Impact strength (NII) was determined on one-eighth inch (3.18 mm) bars per ASTM D256-04 at a temperature of 23° C., and is reported in units of kilogram-centimeters percentimeter (Kg-cm/cm). Tensile strength was determined according to ASTM D638-03, and is reported in kilograms per square centimeter (Kg/cm²). Flexural modulus was determined according to ASTM D790-03, and is reported in kilograms per square centimeter (Kg/cm²).

Spiral flow testing was performed according to the following procedure. A molding machine with a barrel capacity of 3 to 5 ounces (85 to 140 g) and channel depths of 0.03, 0.06, 0.09, or 0.12 inches (0.76, 1.52, 2.29, or 3.05 millimeters, respectively) is loaded with pelletized thermoplastic composition. The mold and barrel are heated to a temperature suitable to flow the polymer, typically 285 to 330° C. The thermoplastic composition, after melting and temperature equilibration, is injected into the selected channel of the mold at 1500 psi (10.34 MPa) for a minimum flow time of 6 seconds, at a rate of 6.0 inches (15.24 cm) per second, to allow for maximum flow prior to gate freeze. Successive samples are generated using a total molding cycle time of 35 seconds. Samples are retained for measurement either after 10 runs have been completed, or when successively prepared samples are of consistent size. Five samples are then collected and measured to within the nearest 0.25 inches (0.64 cm), and a median length for the five samples is reported.

Comparative Examples 1-17 and Examples 1-16 were prepared by extrusion as described above, using the components from Table 1. Comparative Examples 1-17 were prepared according to the proportions given in Table 2 (below) and Examples 1-16 were prepared according to the proportions described in Table 3 (below). Pelletized samples of the resulting extruded compositions were analyzed for melt flow and viscosity, and injection molded into bars to measure flexural modulus and fatigue.

TABLE 2*

| | Comparative Example No. | | | | | | | | |
|---|---|---|---|---|---|---|---|---|---|
| Material | CEx 1 | CEx 2 | CEx 3 | CEx 4 | CEx 5 | CEx 6 | CEx 7 | CEx 8 | CEx 9 |
| PC-Siloxane | 12.500 | 12.500 | 12.500 | | 6.250 | 12.500 | | 12.500 | 12.500 |
| BPA-PC 35K | | 82.500 | | | 30.420 | | | | |
| BPA-PC 30K | 87.500 | | | 95.000 | 30.420 | 87.500 | 95.000 | 87.500 | 87.500 |
| BPA-PC HF | | | 82.500 | | 30.420 | | | | |
| I-168 | 0.060 | 0.060 | 0.060 | 0.060 | 0.060 | 0.060 | 0.060 | 0.060 | 0.060 |
| SAN | | 5.000 | 5.000 | 5.000 | 2.500 | | 5.000 | | |
| PMMA | | | | | | | | | |
| Pigment 4 | 0.006 | 0.006 | 0.006 | 0.006 | 0.006 | 0.006 | 0.006 | 0.006 | 0.006 |
| Pigment 3 | 0.011 | 0.011 | 0.011 | 0.011 | 0.011 | 0.011 | 0.011 | 0.011 | 0.011 |
| Pigment 6 | 0.017 | 0.017 | 0.017 | 0.017 | 0.017 | 0.017 | 0.017 | 0.017 | 0.017 |
| Pigment 1 | 0.073 | 0.073 | 0.073 | 0.073 | 0.073 | 0.073 | 0.073 | 0.073 | 0.073 |
| Pigment 2 | 0.800 | 0.800 | | | 0.400 | | 0.800 | | 0.800 |
| Fatigue 28.2 MPa | 75,301 | 114,568 | 21,126 | 140,950 | 66,274 | 57,701 | 62,068 | 50,195 | 71,054 |
| 5 Hz (cycles) | | | | | | | | | |
| MVR 300° C./1.2 | 8.4 | 3.1 | 20.9 | 7.4 | 6.4 | 5.5 | 7.3 | 5.5 | 5.5 |
| kg (cc/10 min) | | | | | | | | | |
| Flex Modulus | 22,820 | 23,380 | 24,150 | 24,290 | 23,240 | 22,470 | 23,940 | 22,400 | 22,470 |
| (Kg/cm²) | | | | | | | | | |
| Viscosity 6,000 | 167 | 169 | 79 | 141 | 145 | 164 | 144 | 163 | 161 |
| sec⁻¹ (Pa-s) | | | | | | | | | |

Comparative Example No.

| Material | CEx 10 | CEx 11 | CEx 12 | CEx 13 | CEx 14 | CEx 15 | CEx 16 | CEx 17 |
|---|---|---|---|---|---|---|---|---|
| PC-Siloxane | 12.500 | 12.500 | 6.250 | | 12.500 | 12.500 | 12.500 | 12.500 |
| BPA-PC 35K | 82.500 | | 30.420 | | | | | |
| BPA-PC 30K | | | 30.420 | 95.000 | 6.000 | 6.000 | 78.000 | 68.000 |
| BPA-PC HF | | 82.500 | 30.420 | | 81.500 | 71.500 | 9.500 | 9.500 |
| I-168 | 0.060 | 0.060 | 0.060 | 0.060 | 0.060 | 0.060 | 0.060 | 0.060 |
| SAN | 5.000 | 5.000 | 2.500 | 5.000 | | | | |
| PMMA | | | | | | 10.000 | | 10.000 |
| Pigment 4 | 0.006 | 0.006 | 0.006 | 0.006 | 0.006 | 0.006 | 0.006 | 0.006 |
| Pigment 3 | 0.011 | 0.011 | 0.011 | 0.011 | 0.011 | 0.011 | 0.011 | 0.011 |
| Pigment 6 | 0.017 | 0.017 | 0.017 | 0.017 | 0.017 | 0.017 | 0.017 | 0.017 |
| Pigment 1 | 0.073 | 0.073 | 0.073 | 0.073 | 0.073 | 0.073 | 0.073 | 0.073 |
| Pigment 2 | 0.800 | | 0.400 | | 0.800 | 0.800 | 0.800 | 0.800 |
| Fatigue 28.2 MPa | 111,752 | 20,759 | 58,830 | 121,433 | 24,033 | — | 64,798 | — |
| 5 Hz (cycles) | | | | | | | | |
| MVR 300° C./1.2 | 3.0 | 20.5 | 6.2 | 7.4 | 17.3 | — | 6.0 | — |
| kg (cc/10 min) | | | | | | | | |
| Flex Modulus | 22,890 | 24,010 | 23,660 | 24,010 | 23,100 | — | 22,680 | — |
| (Kg/cm²) | | | | | | | | |
| Viscosity 6,000 | 165 | 81 | 147 | 141 | 102 | — | 154 | — |
| sec⁻¹ (Pa-s) | | | | | | | | |

*Note:
All values are given in weight percent, wherein the sum of BPA-PC, SAN, and PC-siloxane is 100 wt %.

TABLE 3*

| | Example No. | | | | | | | |
|---|---|---|---|---|---|---|---|---|
| Materials | Ex. 1 | Ex. 2 | Ex 3 | Ex. 4 | Ex. 5 | Ex. 6 | Ex. 7 | Ex. 8 |
| PC-siloxane | 7.000 | 7.000 | 9.600 | 12.000 | 12.000 | 10.000 | 7.000 | 12.000 |
| BPA-PC 35K | 73.000 | 71.500 | 75.800 | 60.000 | 78.000 | 60.000 | 80.000 | 68.000 |
| BPA-PC 30K | | | | | | | | |
| BPA-PC HF | | 11.500 | | 13.000 | | 20.000 | 3.000 | |
| I-168 | 0.030 | 0.030 | 0.030 | 0.030 | 0.030 | 0.030 | 0.030 | 0.030 |
| SAN | 20.000 | 10.000 | 14.600 | 15.000 | 10.000 | 10.000 | 10.000 | 20.000 |
| PETS | 0.300 | 0.300 | 0.300 | 0.300 | 0.300 | 0.300 | 0.300 | 0.300 |
| Pigment 4 | 0.003 | 0.003 | 0.003 | 0.003 | 0.003 | 0.003 | 0.003 | 0.003 |
| Pigment 5 | 0.034 | 0.034 | 0.034 | 0.034 | 0.034 | 0.034 | 0.034 | 0.034 |
| Pigment 2 | 0.950 | 0.950 | 0.950 | 0.950 | 0.950 | 0.950 | 0.950 | 0.950 |
| Fatigue 28.2 | 156,570 | 239,674 | 120,540 | 126,940 | 104,339 | 152,805 | 191,534 | 104,376 |
| MPa 5 Hz | | | | | | | | |
| (cycles) | | | | | | | | |
| MVR 300° C. | 6.2 | 4.9 | 4.8 | 6.2 | 4.2 | 5.9 | 4.6 | 5.8 |
| 1.2 kg (cc/10 | | | | | | | | |
| min) | | | | | | | | |
| Flex Modulus | 27,510 | 26,040 | 26,320 | 26,250 | 25,340 | 25,690 | 25,900 | 26,880 |
| (Kg/cm²) | | | | | | | | |
| Viscosity 6,000 | 79 | 107 | 89 | 80 | 106 | 95 | 108 | 74 |
| sec⁻¹ (Pa-s) | | | | | | | | |

| | Example No. | | | | | | | |
|---|---|---|---|---|---|---|---|---|
| Materials | Ex. 9 | Ex. 10 | Ex. 11 | Ex. 12 | Ex. 13 | Ex. 14 | Ex. 15 | Ex. 16 |
| PC-siloxane | 12.000 | 8.080 | 8.080 | 7.000 | 8.080 | 12.000 | 9.500 | 7.000 |
| BPA-PC 35K | 78.000 | 74.250 | 67.500 | 60.000 | 65.000 | 60.000 | 60.000 | 75.000 |
| BPA-PC 30K | | | | | | | | |
| BPA-PC HF | | 5.750 | 7.500 | 20.000 | 14.250 | 13.000 | 10.500 | 4.000 |
| I-168 | 0.030 | 0.030 | 0.030 | 0.030 | 0.030 | 0.030 | 0.030 | 0.030 |
| SAN | 10.000 | 11.920 | 16.920 | 13.000 | 12.670 | 15.000 | 20.000 | 14.000 |
| PETS | 0.300 | 0.300 | 0.300 | 0.300 | 0.300 | 0.300 | 0.300 | 0.300 |
| Pigment 4 | 0.003 | 0.003 | 0.003 | 0.003 | 0.003 | 0.003 | 0.003 | 0.003 |
| Pigment 5 | 0.034 | 0.034 | 0.034 | 0.034 | 0.034 | 0.034 | 0.034 | 0.034 |
| Pigment 2 | 0.950 | 0.950 | 0.950 | 0.950 | 0.950 | 0.950 | 0.950 | 0.950 |
| Fatigue 28.2 | 96,711 | 104,381 | 79,366 | 121,993 | 173,036 | 87,201 | 95,352 | 102,926 |
| MPa 5 Hz | | | | | | | | |
| (cycles) | | | | | | | | |
| MVR 300° C. | 4.0 | 5.0 | 6.5 | 6.6 | 5.4 | 6.2 | 7.7 | 5.8 |
| 1.2 kg (cc/10 | | | | | | | | |
| min) | | | | | | | | |
| Flex Modulus | 24,850 | 25,410 | 26,670 | 25,970 | 25,970 | 25,900 | 27,440 | 25,130 |
| (Kg/cm²) | | | | | | | | |
| Viscosity | 112 | 98 | 78 | 85 | 92 | 79 | 63 | 99 |
| 6,000 sec⁻¹ (Pa-s) | | | | | | | | |

*Note:
All values are given in weight percent, wherein the sum of BPA-PC, SAN, and PC-siloxane is 100 wt %.

Upon analysis of the data in Tables 2 and 3, above, it was found that an increase in the amount of BPA-PC 35K (high molecular weight polycarbonate) generally correlated with both increased fatigue resistance and decreased MVR. Increasing SAN levels in the formulation was found to increase shear thinning, high shear flow, and flexural modulus. Increasing amounts of the PC-siloxane provided improved impact performance. The results of Examples 1-16 (Table 3) were compiled using the Design-Expert® software package from Stat-Ease Inc. (Minneapolis, Minn.), and analyzed for transfer functions that would assist in providing formulations having values for these properties (melt volume rate, high shear viscosity (at ˜6,000 sec⁻¹), cycles to failure under tensile fatigue and flexural modulus) that can be optimized based on a desired proportional balance of one or more of these properties. Based on these data, the following transfer functions were thus obtained for the key properties:
Ln(MVR 6)=(0.019863*[BPA-PC 30K])+(0.034239*[BPA-PC HF])+(8.88802E-003*[BPA-PC 35K])+(5.96793E-003*[PC-SILOXANE])+(0.021097*[SAN])−(2.20941E-004*[BPA-PC 30K]*[BPA-PC HF])+(5.07122E-004*[BPA-PC 35K]*[SAN]);
Flexural Modulus=(3413.62878*[BPA-PC 30K])+(3910.82022*[BPA-PC HF])+(3790.87812*[BPA-PC 35K])−(1138.48989*[PC-SILOXANE])+(3941.05313*[SAN])−(17.83000*[BPA-PC 30K]*[BPA-PC 35K])+(34.58258*[BPA-PC 30K]*[PC-SILOXANE])+(261.89083*[PC-SILOXANE]*[SAN]);
High Shear Viscosity=(0.24530*[BPA-PC 30K])+(0.90831*[BPA-PC HF])+(2.35804*[BPA-PC 35K])+(1.96366*[PC-SILOXANE])+(23.80762*[SAN])+(0.10721*[BPA-PC 30K]*[PC-SILOXANE])−(0.28483*[BPA-PC HF]*[SAN])−(0.36398*[BPA-PC 35K]*[SAN])−(0.39835*[PC-SILOXANE]*[SAN]);
Fatigue cycles to failure=(1172.55343*[BPA-PC 30K])+(10817.58357*[BPA-PC HF])+(1951.13000*[BPA-PC 35K])−(3040.43131*[PC-SILOXANE])−(660.86483*[SAN])−(202.25437*[BPA-PC 30K]*[BPA-PC 35K])−(808.69373*[BPA-PC HF]*[PC-SILOXANE]).

Example 17, and Comparative Examples 19-22. The above transfer functions were applied to help determine an optimum composition for an exemplary application having a desired set of properties. Using an optimization program (Microsoft Excel Solver, Microsoft Corporation), an optimized formulation (Example 17) was obtained using the transfer equations determined above. Table 4 shows the formulation determined for Example 17, and the formulation for comparative benchmark compositions, both internally prepared (CEx 19 and 20) and commercially available (CEx. 21 is LUPOY HI-1002ML from LG Chemical; and CEx 22 is STAREX HF-1023IM from Samsung-Cheil Chemical Industries).

TABLE 4

| Material | Ex. 17 | CEx 19 | CEx 20 |
|---|---|---|---|
| PC-siloxane | 7.00 | 12.50 | 17.50 |
| BPA-PC 35K | 75.00 | — | — |
| BPA-PC 30K | — | 6.00 | 37.50 |
| BPA-PC Hi Flow | 4.00 | 81.50 | 45.00 |
| I-168 | 0.03 | 0.06 | 0.03 |
| SAN | 14.00 | — | — |
| PETS | 0.30 | 0.30 | — |
| Pigment 4 | 0.003 | 0.003 | 0.003 |
| Pigment 5 | 0.034 | 0.034 | 0.034 |
| Pigment 2 | 0.950 | 0.950 | 0.950 |

The compositions described in Table 4 (above) were evaluated for different mechanical, thermal, and physical properties. A comparison of the data is provided in Table 5, below.

TABLE 5

| Property | CEx 19 | CEx 20 | Ex. 17 | CEx 21 | CEx 22 |
|---|---|---|---|---|---|
| Tensile Strength at | 697 | 714 | 666 | 712 | 630 |
| 50 mm/min (Kg/cm²) | | | | | |
| Tensile Elongation at | 146 | 142 | 118 | 142 | >100 |
| 50 mm/min (%) | | | | | |
| Flex Stress | 844 | 750 | 970 | 881 | 1,000 |
| (Kg/cm²) | | | | | |
| Flex Modulus | 19,780 | 19,760 | 25,500 | 21,680 | 23,000 |
| (Kg/cm²) | | | | | |
| Izod Impact, notched | 80 | 93 | 91 | 78 | 80 |
| 23° C. (Kg-cm/cm) | | | | | |
| HDT at 18.6 kg/cm² | 137.4 | 138 | 121 | 130.5 | 132 |
| (° C.) | | | | | |
| Melt Flow Rate at 300° C./ | 17.8 | 6.9 | 6.5 | 13.1 | 10 |
| 1.2 kg (cc/10 min) | | | | | |
| Melt Flow Rate at 250° C./ | 28.4 | — | 7 | 22.1 | 10.5 |
| 10 kg (cc/10 min) | | | | | |
| Specific Gravity | 1.19 | 1.19 | 1.19 | 1.19 | 1.19 |
| Fatigue Test 28.2 MPa, | 24,000 | 120,000 | 116,000 | 56,000 | 92,000 |
| 5 Hz (cycles) | | | | | |

As evident from Table 5, the high viscosity at the low-shear rates as provided by the high molecular weight (Mw=35,000) BPA-PC 35K in Example 17 provided very good fatigue resistance. Comparative Example 20 had high fatigue resistance; however, the flexural modulus was low relative to Comparative Examples 21 and 22, and Example 17. High flexural modulus, attributable to the presence of the SAN copolymer, and improved 23° C. notched Izod impact strength attributable to the PC-Siloxane content, are each higher in Example 17 than in the comparative impact modified PC counterparts, including Comparative Examples 21 and 22. In addition, the melt flow rate (MVR) of Example 17 is lower than the comparative examples. Other parameters including tensile strength, tensile elongation, and heat distortion temperature (HDT) are each within acceptable ranges for Example 17.

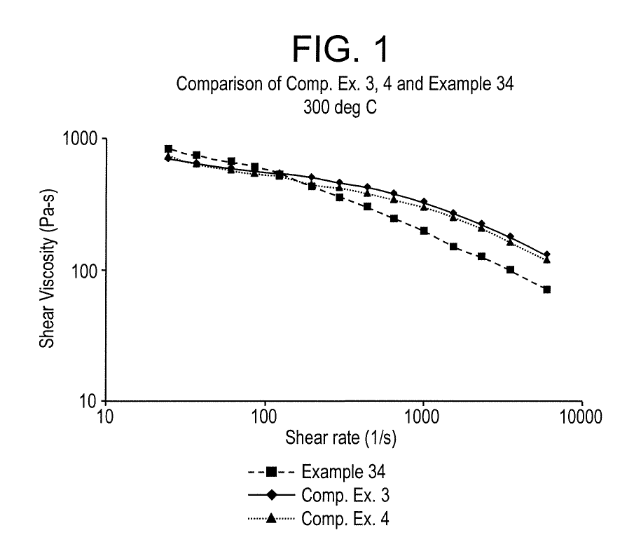

FIG. 1 shows comparison of viscosity (in Pa-s) and shear rate for Example 17 and Comparative Examples 21 and 22. As seen in the plotted curves, Example 17 has a higher viscosity at low shear rates (shear rates of less than or equal to 100 sec⁻¹) and undergoes significant shear thinning to provide lower viscosity at high shear rates (shear rates of greater than or equal to 6,000 sec⁻¹). The comparative examples showed higher high-shear viscosity by comparison.

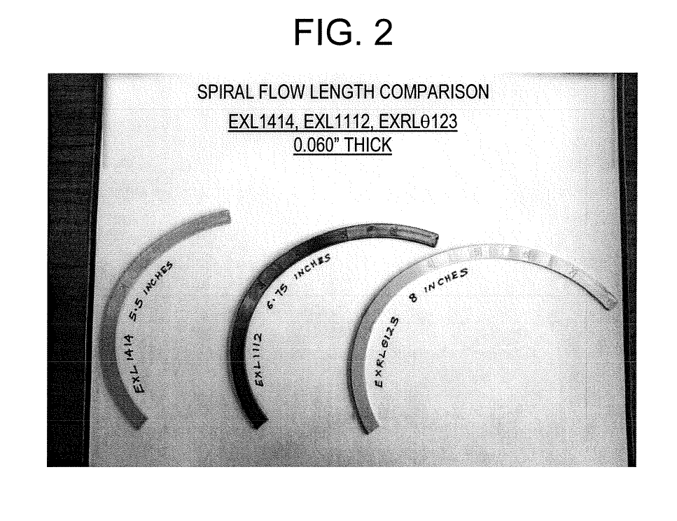

Example 17 was compared with Comparative Examples 19 and 20 using spiral flow testing, to determine the effects of both molecular weight of the components and the inclusion of the SAN component along with the PC-siloxane component. Comparative Examples 19 and 20, as noted in the above data (Table 5), each have lower low-shear viscosity than Example 17. The numerical results are summarized in Table 6, below, and a photographic comparison of the spiral flow samples is provided in FIG. 2.

TABLE 6

| Sample | CEx 19 | CEx 20 | Ex 17 |
|---|---|---|---|
| Length in. (cm) | 5.5 in (14.0 cm) | 6.75 in (17.1 cm) | 8 in (20.3 cm) |

Note:
All spiral molded samples are 0.06 inches (1.52 mm) in thickness.

As seen in the data in Table 6, the spiral mold is filled more completely by the Example 17 composition despite its higher low-shear viscosity. This performance is shown in FIG. 2 (in the figure, CEx. 19 is marked as EXL 1112, CEx 20 is marked as EXL 1414, and Ex 17 is marked as EXRL 0123). It can be seen clearly that the spiral flow length for Example 17 (EXRL0123) is significantly higher than that of Comparative Examples 19 and 20 (EXL1112 and EXL1414, respectively), indicating increased flowability of Example 17 under comparable high shear conditions.

The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference. Further, it should be noted that the terms “first,” “second,” and the like herein do not denote any order, quantity, or importance, but rather are used to distinguish one element from another.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

We claim:

1. A thermoplastic composition comprising a resin composition comprising:
a polycarbonate having a weight averaged molecular weight of greater than or equal to 30,000 as measured using gel permeation chromatography,
a polysiloxane-polycarbonate comprising 1 to 50 weight percent of siloxane units; and
a SAN copolymer,
wherein the amounts of polycarbonate, polysiloxane-polycarbonate, and SAN copolymer are selected such that fatigue failure for the thermoplastic composition occurs at greater than or equal to 70,000 cycles at a pressure of 28.2 MPa and a frequency of 5 Hz according to ASTM D638-03 type I, and the viscosity of the thermoplastic composition is less than or equal to 112 Pa-s when measured at a shear rate of 6,000 sec⁻¹ and at 300° C. according to ASTM D4440-01.

2. The thermoplastic composition of claim 1, wherein the polycarbonate is present in the resin composition in an amount of 65 to 87 weight percent, wherein the polysiloxane-polycarbonate is present the resin composition in an amount of 3 to 15 weight percent, and the SAN copolymer is present the resin composition in an amount of 10 to 20 weight percent, and wherein the combined amounts of polycarbonate, polysiloxane-polycarbonate, and SAN copolymer is 100 weight percent of the resin composition.

3. The thermoplastic composition of claim 1, wherein the polycarbonate comprises greater than or equal to 90 wt % of a linear polycarbonate.

4. The thermoplastic composition of claim 3, wherein the linear polycarbonate is bisphenol A polycarbonate.

5. The thermoplastic composition of claim 1, wherein the resin composition comprises 0.6 to 3 weight percent polysiloxane as provided by the polysiloxane-polycarbonate, based on the total weight of the resin composition.

6. The thermoplastic composition of claim 1, wherein the polysiloxane-polycarbonate is free of Si—O—C bonds.

7. The thermoplastic composition of claim 6, wherein the polysiloxane-polycarbonate comprises polydimethylsiloxane units and bisphenol-A carbonate units.

8. The thermoplastic composition of claim 1, wherein the SAN copolymer comprises styrene and acrylonitrile in a ratio of 65:35 to 85:15.

9. The thermoplastic composition of claim 8, wherein the weight averaged molecular weight of the SAN copolymer is 30,000 to 150,000, as measured using gel permeation chromatography.

10. The thermoplastic composition of claim 1, further comprising an impact modifier, filler, antioxidant, heat stabilizer, light stabilizer, ultraviolet light absorber, plasticizer, mold release agent, lubricant, antistatic agent, pigment, dye, flame retardant, anti-drip agent, or a combination comprising at least one of these.

11. The thermoplastic composition of claim 1 wherein the tensile strength is greater than or equal to 650 kg/cm², as measured at 50 mm/min according to ASTM D638-03.

12. The composition of claim 1, wherein the flexural modulus is greater than or equal to about 23,000 kg/cm² as measured at 2.8 mm/min. according to ASTM D790-03.

13. The thermoplastic composition of claim 1, wherein the notched Izod impact strength is greater than or equal to 70 kg-cm/cm, as measured on 3.18 mm bars at 23° C. according to ASTM D256-04.

14. The thermoplastic composition of claim 1, wherein the viscosity of the thermoplastic composition is greater than or equal to 900 Pa-s when measured at a shear rate of 25 sec⁻¹ and at 300° C. according to ASTM D4440-01.

15. A thermoplastic composition comprising a resin composition comprising:
65 to 87 weight percent of a polycarbonate, wherein the polycarbonate comprises greater than or equal to 90 wt % of a linear polycarbonate, and wherein the polycarbonate has a weight averaged molecular weight of greater than or equal to 30,000 as measured using gel permeation chromatography, 3 to 15 weight percent of a polysiloxane-polycarbonate, wherein the polysiloxane-polycarbonate comprises 1 to 50 weight percent of siloxane units; and
10 to 20 weight percent of a SAN copolymer, wherein the resin composition comprises 0.6 to 3 weight percent polysiloxane as provided by the polysiloxane-polycarbonate, based on the total weight of the resin composition, and wherein the combined amounts of polycarbonate, polysiloxane-polycarbonate, and SAN copolymer is 100 weight percent of the resin composition.

16. The thermoplastic composition of claim 15 wherein fatigue failure for the thermoplastic composition occurs at greater than or equal to 70,000 cycles at a pressure of 28.2 MPa and a frequency of 5 Hz according to ASTM D638-03 type I.

17. The thermoplastic composition of claim 15, wherein the viscosity of the thermoplastic composition is less than or equal to 112 Pa-s when measured at a shear rate of 6,000 sec⁻¹ and 300° C. according to ASTM D4440-01.

18. A resin composition comprising:
a polycarbonate having a weight averaged molecular weight of greater than or equal to 30,000 as measured using gel permeation chromatography,
a polysiloxane-polycarbonate comprising 1 to 50 weight percent of siloxane units; and
a SAN copolymer,
wherein the amounts of polycarbonate, polysiloxane-polycarbonate, and SAN copolymer are selected such that fatigue failure for a thermoplastic composition prepared from the resin composition occurs at greater than or equal to 70,000 cycles, at a pressure of 28.2 MPa and a frequency of 5 Hz, according to ASTM D638-03 type I, and wherein the viscosity of the thermoplastic composition is less than or equal to 112 Pa-s when measured at a shear rate of 6,000 sec⁻¹ and at 300° C. according to ASTM D4440-01.

19. A method of making a thermoplastic composition comprising melt blending:
a polycarbonate having a weight averaged molecular weight of greater than or equal to 30,000 as measured using gel permeation chromatography,
a polysiloxane-polycarbonate comprising 1 to 50 weight percent of siloxane units; and
a SAN copolymer,
wherein the amounts of polycarbonate, polysiloxane-polycarbonate, and SAN copolymer are selected such that fatigue failure for the thermoplastic composition occurs at greater than or equal to 70,000 cycles, at a pressure of 28.2 MPa and a frequency of 5 Hz, according to ASTM D638-03 type I, and the viscosity of the thermoplastic composition is less than or equal to 112 Pa-s when measured at a shear rate of 6,000 sec⁻¹ and at 300° C. according to ASTM D4440-01.

20. An article comprising the thermoplastic composition of claim 1.
